(19) United States
(12) Patent Application Publication
(10) Pub. No.: US 2003/0194680 A1
(43) Pub. Date: Oct. 16, 2003

(54) Dental implant fixture

(76) Inventor: Urpo Ristola, Jyvaskyla (FI)

Correspondence Address: YOUNG & THOMPSON, 745 SOUTH 23RD STREET 2ND FLOOR, ARLINGTON, VA, 22202

(21) Appl. No.: 10/430,218

(22) Filed: May 7, 2003

Related U.S. Application Data
(63) Continuation of application No. PCT/FI01/00928, filed on Oct. 26, 2001.

(30) Foreign Application Priority Data
Nov. 10, 2000 (FI) 20002473

(51) Int. Cl. A61C 8/00

(52) U.S. Cl. 433/173

(57) ABSTRACT

The present invention relates to a dental implant fixture comprising an implant root, which is adapted affixable into a jaw bone by means of an outer thread and has an inner thread made thereto, and a spacer stud having made thereto an outer thread compatible with the said implant root inner thread. The spacer stud has threads made thereto at least in the portion thereof projecting distally from the implant root and the fixture further incorporates a locking nut with an inner thread compatible with the outer thread of the projecting portion of the spacer stud.

The present invention relates to a dental implant fixture serving for securing the crown of a dental implant to the jaw bone or, alternatively, using the fixture for affixing a dental prosthesis or a part thereof in place.

In principle, fixtures used for this purpose comprise a proximal implant root portion and a distal fixture portion securable thereon. The implant root is fitted into a hole drilled in the jaw bone and is secured in place by means of a coarse-pitch outer thread made on the implant root portion. The implant portion has an internal bore made thereto axially and threaded internally. During the affixing of the implant root portion, into this threaded bore is screwed a spacer stud. After the spacer stud is screwed and tightened in place into the implant root, there remains visible the projecting end of the spacer stud on which the crown of the dental implant is mounted or, alternatively, the stud serves as a fixture for a tooth prosthesis. A problem hampering these fixtures has been a gradual loosening of the connection between the implant root portion and the spacer stud. Basically, this complication can be traced to the sporadically in the mouth occurring wide temperature excursions that attack the fixture elements of the different parts of the dental implant at different times and in different magnitudes.

A remedy to the above-described problem has been sought from constructions based on mutual dimensioning and shaping of the threads connecting the implant root to the spacer stud so that these elements would lock to each other during the affixing of the spacer stud in a manner resistant to dimensional changes in the different parts of the fixture due to temperature variations. Such arrangements are described, e.g., in U.S. Pat. Nos. 5,607,304, 5,605,457, 5,660,545 and 5,823,777. However, none of these have been able to overcome the above-described problems.

It is an object of the present invention to overcome the recognized problem by way of a novel arrangement characterized by what is stated in the characterizing part of claim 1 in the appended claims.

In the present embodiment, it has been found that a locking nut tightened on the threads of the portion of the spacer stud projecting distally from the implant root against the implant root is an effective means for locking the fixture to the implant root so that dimensional changes caused by temperature variations work mutually in a substantially compensating manner in the assembly. Hence, the degree of tightening of the spacer stud stays essentially unchanged under the temperature variations attacking the implant fixture.

In the following, the invention will be explained in more detail by making reference to the appended drawings, wherein

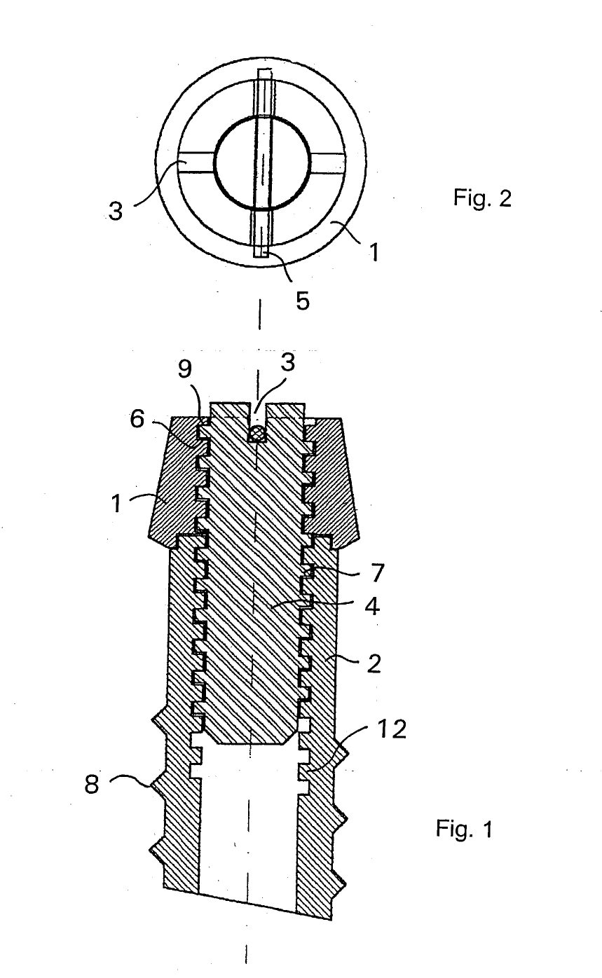

FIG. 1 shows a longitudinal cross-sectional view of a dental implant fixture according to the invention; and

FIG. 2 shows the same fixture in a top view.

Referring to FIG. 1, the dental implant fixture shown therein primarily comprises an implant root 2 whereon is formed a suitable outer thread 8. This thread serves to affix the implant root into a hole drilled in the jaw bone, wherein it allowed to settle and osseointegrate. The implant root is provided with an axial bore having an inner thread 12 made therein. Adapted anchorable into this inner thread, the fixture system further includes a spacer stud 4 having made thereon an outer thread 7 compatible with the inner thread of the implant root. The spacer stud 4 is dimensioned to have such a length that a substantial portion thereof remains distally projecting from the implant root when after the stud is screwed in place into the implant root. This projecting portion is respectively threaded with a thread 9. The threads 7 and 9 of the spacer stud need not necessarily be similar and, further, the threads need not necessarily be a continuation of each other. In regard to simpler fabrication, however, the threads 7 and 9 are advantageously machined as a continuous outer thread.

In addition to the above-mentioned elements, the dental implant fixture according to the invention includes a locking nut 1. This nut has an inner thread compatible with thread 9 of the projecting portion of spacer stud 4.

During the time of the osseointegration period of the implant root 2, the axial bore of the implant is conventionally kept plugged with a healing cap that is screwed into the thread 12. After the laps of the healing period, the cap is removed and the spacer stud is screwed to a desired depth into the implant root. Thereupon, onto the thread 9 of the projecting portion of the spacer stud is screwed the locking nut 1 that is tightened with a correct torque against the projecting end of the implant root. The proper torque value is assured by using a purpose-designed torque-controlling tool for tightening.

The final position of the locking nut 1 is advantageously secured relative to the spacer stud 4, wherein different kinds of arrangements can be employed. In the embodiment shown in the diagrams, locking is accomplished by means of a slot made to the end of the spacer stud, a compatible slot made to the end of the locking nut 1 and a locking pin 5 inserted therein.

As the function of the dental implant fixture, it has been found advantageous to have the threads 12, 7 and 9 made into fine-pitch square of acme threads, commonly used in certain machine elements for power transmission.

This fixture construction has proven to retain an essentially constant securing tightness between the implant root 2 and the locking nut 1 under varying thermal stresses imposed on the fixture.

Furthermore, the arrangement according to the invention facilitates flexible shaping and/or furnishing of the locking nut for affixing different dental prosthesis components. For instance, one nut type may be shaped for affixing a crown while another nut type serves for affixing a bridge or a part of a dental prosthesis.

What is claimed is:

1. A dental implant fixture comprising:
a cylindrical implant root having a first end and a second end and a length extending between said ends, and an axial central boring extending into a depth from said first end, the outer periphery of said implant root being provided at least along a part of its length from said second end with an outwards projecting thread for affixing said root into a jaw bone, and said axial central boring being provided at least a part of its depth from said first end with an inner thread;
a spacer stud having a first end and a second end and a length extending between said ends, said spacer stud being provided at least along a part of its length from said first end with an outer thread compatible with said implant root inner thread in said axial central boring of said implant root;
a locking nut having an axial central boring provided with an inner thread compatible with the outer thread of said spacer stud, wherein
the inner thread in said central boring of said implant root, the outer thread of the spacer stud and said inner thread in said central boring of said locking nut are selected from square thread and acme thread.

2. The dental implant fixture of claim 1, wherein the inner thread in said central boring of said implant root, the outer thread of the spacer stud and said inner thread in said central boring of said locking nut all are square threads.

3. The dental implant fixture of claim 1, wherein the first end of said spacer stud incorporates means to lock a mutual threaded position of said spacer stud and said locking nut.

4. The dental implant fixture of claim 1 or 2, wherein said locking nut is shaped and/or furnished for affixing a crown or a dental prosthesis thereto.
